(19) United States
(12) Patent Application Publication
(10) Pub. No.: US 2025/0269430 A1
(43) Pub. Date: Aug. 28, 2025

(54) Method and System for Controlling a Manufacturing Process for Additively Manufacturing a Component

(71) Applicant: EOS GMBH ELECTRO OPTICAL SYSTEMS, Krailling (DE)

(72) Inventors: Martin Heugel, Landsberg am Lech (DE); Ulrich Kleinhans, Prittriching (DE); Johannes Rumpel, Dasing (DE); Philip Ströbel, Weidenbach (DE)

(21) Appl. No.: 18/867,436

(22) PCT Filed: May 22, 2023
(86) PCT No.: PCT/EP2023/063677

§ 371 Date: Nov. 19, 2024

(30) Foreign Application Priority Data
May 30, 2022 (DE) 102022113609.4

(51) Int. Cl. B22F 10/32; B22F 10/77; B22F 10/85; B22F 12/70; B33Y 30/00; B33Y 50/02

(52) U.S. Cl. CPC B22F 10/32; B22F 10/77; B22F 10/85; B22F 12/70; B33Y 50/02; B33Y 30/00

(57) ABSTRACT

Disclosed is a method for controlling a manufacturing process for additive manufacturing. In the method, a process gas loaded with contamination is discharged from a process space through a gas pipe, filtered and returned to the process space. The method further includes detecting a number of measuring values by a contamination measuring unit, each measuring value allowing an inference of a degree of contamination of the process gas flowing through the gas pipe prevailing at the time of detection, evaluating the number of measuring values, and controlling the device and/or an output device data-technically connected to the manufacturing process in dependence on the evaluation of the number of measuring values. Further disclosed is a corresponding system and a manufacturing device.

The invention relates to a method and a system for controlling a manufacturing process for additive manufacturing of a component in a device, wherein building material is built up on a construction field layer by layer, in particular between the application of two material layers of building material, by means of a, in particular selective, solidification of building material by irradiation of the building material with at least one energy beam.

Additive manufacturing processes are becoming increasingly relevant in the production of prototypes and now also in series production. In general, “additive manufacturing processes” are manufacturing processes in which a manufacturing product (“component”) is built up on the basis of digital 3D design data by depositing material (the “building material”). The structure is usually, but not necessarily, built up in layers. The term “3D printing” is often used as a synonym for additive manufacturing, the production of models, samples and prototypes using additive manufacturing processes is often referred to as “rapid prototyping”, the production of tools as “rapid tooling” and the flexible production of series components as “rapid manufacturing”. As mentioned at the beginning, a key point is the selective solidification of the building material, wherein this solidification can take place in many manufacturing processes with the help of irradiation with radiation energy, e.g. electromagnetic radiation, in particular light and/or heat radiation, but possibly also with particle radiation such as electron radiation. Examples of processes using irradiation are “selective laser sintering” or “selective laser melting”. In this process, thin layers of a mostly powdery building material are repeatedly applied on top of each other and in each layer the building material is selectively solidified in a “welding process” by spatially limited irradiation of the areas that are to be part of the component to be manufactured after production, in which the powder grains of the building material are partially or completely melted with the help of the energy introduced locally by the radiation at this point. During cooling, these powder grains then solidify together to form a solid. In most cases, the energy beam is guided along solidification paths across the construction field and the remelting or solidification of the building material in the respective layer takes place in the form of “weld paths” or “weld beads”, so that ultimately a large number of such layers formed from weld paths are present in the component. In this way, components with very high quality and breaking strength can now be produced.

The manufacturing process often takes place in a protective gas atmosphere. For this purpose, a process gas, e.g. argon, flows through the process chamber. Generally, the process gas is not released into the environment afterwards, but is fed back into the process chamber. Particularly in additive manufacturing with metallic building material, the process gas is contaminated with particles within this gas cycle. These can be particles of the building material, but also particles that are produced during the solidification process. Furthermore, additional particles may be introduced into the process gas flow, e.g. a passivating agent such as chalk, which can be added to the process gas flowing out of the process chamber in the case of a metallic building material for fire protection reasons.

The process gas is usually filtered to clean it. However, despite this, it can happen, e.g. due to a filter breakage, that the process gas fed into or returned to the process chamber is contaminated with particles, which leads to a reduction in the quality of the manufactured components. In general, a permeability at the filter stage can lead to major disadvantages in the quality of the manufactured components, but also to machine damage, especially because it can remain undetected for a long time.

To reduce the risk of contamination due to filter breakthroughs, process gas is filtered e.g. by using a two-stage filter system. Filter breakthroughs at the main filter (or pre-filter) can be compensated and indirectly detected with the help of a downstream fine filter (often a storage filter that cannot be cleaned), as this becomes clogged relatively quickly in the event of a breakthrough, which leads to increased differential pressure at the filter that can be detected by a differential pressure sensor or can cause a pressure switch to be actuated, which in turn can lead to production being interrupted. In fault-free operation, the first filter stage allows a small proportion of particles to pass through. The fine filter reduces this proportion to a minimum of finest parts (condensate), for example, which reaches the clean gas side of the process gas circuit.

In another frequently used filter unit, the filtrate is first mixed with chalk powder just upstream of the filter, wherein a downstream fine- or storage filter is not used. This creates the problem that if the filter is permeable, chalk can also reach the clean gas side of the process gas circuit unnoticed and be introduced into the process chamber during the ongoing construction process. The chalk can settle as dust on the powder bed or on the solidified areas and be integrated into the structure of a component. This can impair component properties such as strength.

It is an object of the present invention to provide a method and a system for controlling a manufacturing process for the additive manufacturing of a component, which overcomes the disadvantages of the prior art and in particular allows automatic detection of filter breakthroughs.

This object is solved by a method according to patent claim 1, a system according to patent claim 10 and a device according to patent claim 13.

A method according to the invention is used for controlling a manufacturing process for additive manufacturing of a component in a device, wherein building material is solidified on a construction field in a process space by means of irradiation of the building material with at least one energy beam and wherein a process gas loaded with contamination is discharged from the process space through a gas pipe, filtered and returned to the process space. The method comprises the following steps:
detection of a number of measuring values by means of a contamination measuring unit, each measuring value allowing an inference of to a degree of contamination of the process gas flowing through the gas pipe at the time of detection,
evaluation of the number of measuring values,
controlling the device and/or an output device data-technically connected to the manufacturing process in dependence on the evaluation of the number of measuring values.

As already indicated, in a manufacturing process in a construction field, building material is built up in layers, i.e. successively in several material application levels or material layers. The building material is preferably a metal powder. However, the invention is not limited to this, but can also be used with other, preferably powdery, build-up materials, such as plastics or ceramics or mixtures of the various materials. The building material is (in particular selectively) solidified, in particular between the application of two layers of material, by irradiating the building material with at least one energy beam generated by an irradiation unit of the manufacturing device (this refers to an energetic beam of photons or particles, e.g. a light beam or an electron beam). Not only is the building material in the upper, freshly applied material layer captured by the energy beam and melted or remelted, but the energy beam usually goes a little deeper into the material bed and also reaches underlying, already remelted material from previously applied material layers.

“Contamination” basically refers to any solid or liquid particles that contaminate the process gas. This includes, in particular, discharge materials or other contamination from the process chamber, but can also include contamination that occurs downstream of the process chamber, in particular based on added passivating agents. For example, impurities can be smoke particles or particles of the building material (discharge material) or chalk (passivation agent) or mixtures of these particles.

The degree of contamination refers to the amount of contamination in the process gas. This degree can generally be specified with a proportion of particles or “contamination elements”, but materials that contaminate the process gas can also be itemized proportionally.

Contamination of the process gas can be caused by a variety of processes. For example, the contamination depends on the flow rate, in particular on the insertion or extraction of the process gas, but also on the dosing process (powder can trickle out of the dosing unit due to excessive rotation of the roller or a defect in the powder seal), the passage of the coater (powder that has not yet settled on the powder bed after the layering device is caught by the gas flow and further stirred up), the construction process and/or laser activity, a collision between the layering device and the component (whirling up powder), defects or design flaws (dust collects on the layering device and is whirled up by blowing), operating errors (e.g. forgetting to fit the sealing lip on the dispenser) or disregarding cleaning cycles (dust settling on surfaces).

A contamination measuring unit is used to record measuring values, which can be, for example, a dust sensor known in the prior art. A measurement can be carried out in particular optically, e.g. via turbidity according to the smoke detector principle, acoustically, e.g. via ultrasound, e.g. triboelectrically according to the principle of ionization smoke detectors, electrochemically or electromagnetically, e.g. by means of a microwave Doppler sensor. It is also preferred to use any thermo-optical measuring devices available for process monitoring with regard to characteristic measuring values caused by interaction of a laser beam with an impure process atmosphere, or by changed processes in the melt-pool due to this very interaction. The monitoring of optical images taken through a possibly cloudy process atmosphere is also preferred, particularly with regard to their brightness and contrast ratio. A preferred measuring unit is minimally invasive, structurally easy to integrate into a system, wear-free, reliable and cost-effective.

The contamination measuring unit measures the particle load of the process gas flowing past, in particular on the clean gas side of the process gas circuit, i.e. between a filter and the inlet to the process chamber. The measurement can be continuous or intermittent. A preferred arrangement of a sensor of the contamination measuring unit in the machine is such that the sensor can detect approximately the entire inner diameter of the pipe in which it is arranged. If it is arranged in an area of the outlet pipe, the sensor should be arranged where this pipe runs straight for as long as possible, in particular if the area is divided into thirds, preferably two thirds of the distance downstream of the nearest bend and one third of the distance upstream of the nearest bend. During a measurement, the flow in the pipe should be as homogeneous as possible and run freely. With regard to the alignment of the sensor to the pipe cross-section) (360°, the sensor is preferably positioned at 90° to the main flow direction and detects the widest possible range of loading mass flows, i.e. it should be positioned along the maximum diameter of the pipe.

The measuring values recorded by the contamination measuring unit should allow a conclusion to be drawn about the degree of contamination of the process gas flowing through the gas line at the time of detection. This means that each measured value directly indicates this respective degree of contamination or represents a value that can be used to determine the degree of contamination, e.g. based on powder bed monitoring. Preferred measuring values indicate, for example, the total number of particles per time, but can also indicate a mass or electrical charge of the individual particles, wherein an additional measurement of the flow velocity could also be helpful here. In addition, it can also be advantageous to measure the homogeneity or heterogeneity of the flow, i.e. whether the flow velocities are largely the same or different across the inner cross section of the pipe. Further preferred measuring values indicate a distribution of particles in the flow across the inner cross-section of the pipe. For example, after a bend in a wall area of the greatest arc length, the concentration of particles, in particular heavier particles, may be higher due to the effect of the centrifugal force. In short, all measurements that provide information on how many particles flow back into the process chamber together with the process gas are preferred.

It should be noted that the degree of contamination at the gas outlet of the process chamber (in the raw gas section) alone can be measured. However, it is preferred to measure the degree of contamination in the clean gas section (at the gas inlet to the process chamber or the process gas after filtering). However, it can also be very advantageous to measure in the raw gas section and in the clean gas section, as differential values can then also be formed, which can provide very good information about changes in the filters.

The evaluation of the number of measuring values is preferably carried out with regard to the quality of the components. If the contamination of the process gas is too high, this should be counteracted so that this contamination does not excessively affect the process chamber and the components to be manufactured in it. For example, it is easy to check whether the level of contamination in the process gas is above a predetermined threshold value, in particular for a chalk content of the particles. However, other indicators would also be possible, e.g. a sudden increase in the level of contamination or an increase in a certain concentration of certain particles, e.g. larger particles or chalk particles. The contamination measuring unit can be integrated into a diagnostic system in which, for example, the measured values are combined with measuring values from another sensor system (e.g. as part of a “differential diagnosis”). For example, the measuring values could be linked with control data from the control of all moving elements in the process chamber (layering device including individual parts, etc.) as well as the gas injection or gas extraction, or a temporal correlation could be formed between an increase in powder discharge and a specific event or activity of a specific component. Correlations can also be formed between fault events via other sensors or signals can be weighted and interpreted, thereby narrowing down the components or events causing the fault.

With regard to the control of the device or the output device, a manufacturing process can be interrupted until the degree of contamination is back within a tolerable range. However, a warning can also be issued, e.g. that a filter breakage is likely. For example, a warning signal is issued if a threshold value is exceeded, e.g. if the total amount of powder discharged is too large or if defined threshold values for local maxima/minima or graph-gradients are exceeded. Between control and evaluation, an error diagnosis can be carried out to determine where the error could lie.

A system according to the invention is used for controlling a manufacturing process for additive manufacturing of a component in a device, wherein building material is solidified on a construction field in a process space by means of irradiation of the building material with at least one energy beam and wherein a process gas loaded with contamination is discharged from the process space through a gas pipe, filtered and returned to the process space. The system is designed in particular for carrying out the method according to the invention and comprises the following components:
a contamination measuring unit designed to detect a number of measuring values, each measuring value allowing an inference of the degree of contamination in the process gas flowing through the gas pipe,
an evaluation unit (32) designed for the evaluation of the number of measuring values,
a control unit (29) designed for controlling the device and/or an output device data-technically connected to the manufacturing process in dependence on the evaluation of the number of measuring values.

The invention has the advantage that particle-laden process gas can be detected and, if necessary, a shutdown of the process can be initiated or a warning issued. This prevents defects in components caused by an inadequately filtered process atmosphere, which could possibly remain undetected for a long time. Contamination can both worsen the manufacturing process directly by interfering with the laser beam and lead to contaminated powder which, even if sieved afterwards, can in turn cause damage in parts made from it that is difficult to detect. In particular, minimal filter breakthroughs that do not lead to a job abort on the basis of other control mechanisms (e.g. due to an abrupt significant drop in back pressure independent of a cleaning process) can be reliably detected by the invention. In this way, it is possible to prevent impairment of the component quality, in particular due to excessive chalk ingress (passivation means), over a longer period of time during which the process gas cleaning system supposedly functions perfectly.

A device according to the invention (“manufacturing device”) for additive manufacturing of a component in a manufacturing process in which building material is solidified on a construction field in a process space by means of irradiation of the building material with at least one energy beam, comprises the following components:
a gas pipe for conducting a process gas from the process space through a filter unit and back into the process space,
a system according to the invention, wherein the contamination measuring unit of the system is arranged in the gas pipe, preferably on a clean gas side of the gas pipe.

Preferably, the filter unit has at most two stages, preferably at most one stage. “Single-stage” means that the filter unit can comprise filter elements connected in parallel, but no filter elements connected in series. It is preferred that at least one filter element, preferably all filter elements of the filter unit, is/are designed to be cleaned before, during or after a manufacturing process. This means that the filter is not a storage filter. Preferably, a particle separation unit is connected upstream of the filter unit.

It should be pointed out at this point that the device according to the invention can also have several irradiation devices, which are then controlled in a correspondingly coordinated manner with the control data, as mentioned above. It should also be mentioned once again that, in this respect, the energy beam can also consist of several superimposed energy beams or that the energy beam can be as well particle radiation as electromagnetic radiation, such as light or preferably laser beam.

A control device according to the invention is used to control a device for additive manufacturing of a component, wherein building material is solidified on a construction field in a process space by means of irradiation with at least one energy beam and wherein a process gas loaded with contamination is discharged from the process space through a gas pipe, filtered and returned to the process space. The control device is designed to control the manufacturing device in accordance with the method according to the invention, or comprises a system according to the invention.

In particular, the invention can be realized in the form of a computer unit, especially in a control device, with suitable software. This refers in particular to the creation of the control data, as the production of a component is carried out by means of further components. The computer unit can, for example, have one or more microprocessors or the like that work together for this purpose. In particular, it can be realized in the form of suitable software program parts in the computer unit. A largely software-based realization has the advantage that previously used computer units, in particular in control devices of manufacturing devices, can also be easily retrofitted by a software or firmware update in order to work in the manner according to the invention. In this respect, the task is also solved by a corresponding computer program product with a computer program which can be loaded directly into a memory device of a computer unit, with program sections to carry out all steps of the method according to the invention (at least those relating to the generation of control data, but possibly also those serving to transmit the control data for a manufacturing process) when the program is executed in the computer unit. In addition to the computer program, such a computer program product may include additional components such as documentation and/or additional components, including hardware components such as hardware keys (dongles, etc.) for using the software. A computer-readable medium, for example a memory stick, a hard disk or another transportable or permanently installed data carrier, on which the program sections of the computer program that can be read in and executed by a computer unit are stored, can be used for transport to the computer unit and/or for storage on or in the computer unit.

Further, particularly advantageous embodiments and further embodiments of the invention result from the dependent claims and the following description, wherein the independent claims of one claim category can also be further developed analogously to the dependent claims and embodiment examples of another claim category and, in particular, individual features of different embodiment examples or variants can also be combined to form new embodiment examples or variants.

According to a preferred method, in the event that the evaluation of the number of measuring values shows that the degree of contamination in the process gas flowing through the gas pipe is greater than a predetermined maximum contamination (a threshold value for the degree, e.g. a particle concentration), at least one of the following steps is carried out:
output of information on the output device, in particular a warning message (a notice) or a warning signal (e.g. an acoustic or visual signal),
interrupting (i.e. stopping or pausing) the manufacturing process,
automatic entry of information about the degree of contamination in the process gas flowing through the gas pipe, determined from the number of measuring values, in a quality data log,
determination of a condition of a number of components produced in the manufacturing process and estimation of which of the number of components is/are usable and which is/are not.

According to a preferred method, for controlling the device, the evaluation of the number of measuring values is carried out taking into account a number of process parameters of the device which are characteristic of additive manufacturing of a component. This is done in particular under the assumption that the detected contamination is process-related discharge material (in particular powdered application material) and/or passivating agent (in particular chalk). Alternatively or additionally, the device is controlled by means of a, in particular automatic, control or regulation of the number of process parameters depending on the evaluation of the number of measuring values, wherein preferably, with regard to the control or regulation of the number of process parameters, an optimization and/or an error detection occurs with regard to at least one process parameter taking place on the basis of the evaluation of the number of measuring values. Optimization or error detection with regard to at least one process parameter can be carried out on the basis of targeted tests or based on estimates. For example, when measuring the build-up material in the process gas flow, the flow of the process gas through the process chamber can be changed in a targeted manner or the energy beam can be regulated when measuring smoke particles.

According to a preferred method, a process parameter of the number of process parameters is characteristic of at least one of the following criteria:
a throughput, a flow rate, a direction, an effective range and/or a velocity of the process gas in the process space, in particular in each case relative to an uppermost layer of the building material,
a geometric and/or temporal uniformity of a throughput, a flow rate, a direction, an effective range and/or a velocity of the process gas in the process space, in particular in each case relative to an uppermost layer of the building material,
an area, thickness, position and/or shape of an area to be consolidated on the construction field for the production of the component,
feeding and/or selective solidification of the building material,
a distribution (in particular layer-by-layer application) of the building material,
the at least one energy beam which causes the selective solidification of the building material, in particular its wavelength, intensity, intensity distribution, beam diameter, beam cross-section, direction of deflection, direction of movement and/or speed of movement within the construction field,
a filling and/or overfilling of an overflow container, which is provided for collecting excess building material in the process space,
an increased or uncontrolled discharge of building material into an atmosphere of the Process space.

According to a preferred method, it is determined as part of the evaluation whether a measuring value or a development of a plurality of measuring values is within a predetermined value range. Preferably, the number of measuring values is evaluated in a special way, e.g. by
a measuring value is compared with at least one predefined threshold value and/or
a change in a number of measuring values is compared with at least one predefined threshold value and/or
a plurality of measured values is checked for a repetitive pattern of measuring values, wherein preferably the checking of the number of measured values for the repetitive pattern of measuring values comprises a recognition of repeatedly occurring measuring value anomalies (e.g. temporary measuring value deflections), in particular those which occur for a short time in comparison to the predetermined period of time of the measuring value acquisition. The evaluation of the number of measuring values preferably comprises a formation of a temporal correlation between a result of a recording of the number of measuring values and at least one process parameter of the device, which is characteristic for an additive manufacturing of a component. Examples of such process parameters are given above.

According to a preferred method, the acquisition of a number of measurement values, and preferably also the control or regulation of the process parameter, takes place during additive manufacturing of a component, preferably continuously or at regular time intervals.

According to a preferred method, the building material is at least partially in powder form and preferably comprises a metal powder.

According to a preferred method, a passivating agent, preferably chalk particles, is added to the process gas flowing through the gas pipe downstream of the process space and/or upstream of the filter unit. As stated above, this passivating agent can lead to quality losses if it enters the Process space. Therefore, the use of the method according to the invention is particularly advantageous here.

According to a preferred method, the building material is fed into the process space for the production of a component. A dosing device and/or a laying device is arranged in the process space (for this purpose), which applies the building material layer by layer within a construction field. In the course of controlling the device, the building material is preferably dosed by means of the dosing device and/or the layering device depending on the number of measuring values, which may also take place in a different manner based on the measuring values (i.e. deviating from a previously specified manner). Alternatively or additionally, the dosing device and/or the layering device are preferably moved, possibly also in a modified manner.

Preferably, the contamination measuring unit comprises a filter breakage sensor, in particular based on the triboelectric effect, and/or an optical turbidity sensor, and/or a camera, which in particular monitors the brightness of images taken through the process atmosphere, and/or a thermo-optical measuring device and/or a system designed for powder bed monitoring, and/or a measuring device for comparative measurement of a pressure (the differential pressure) at two parallel filter stages.

A filter breakage sensor is normally positioned downstream of a particle filter in order to check or document the degree of its cleaning effect. Such a filter breakage sensor often works according to the principle of triboelectricity, i.e. the electrical charging of particles through friction. Such a sensor can be designed as a metal rod that penetrates a line of the gas circulation system with the process gas. Penetration can occur at only one point on the wall. Contact between the metal rod and metal pipe can be avoided by using insulation. Electromagnetic shielding of the sensor is very advantageous in order to avoid interference. Electrically charged metal particles that have been charged by friction touch the electrically conductive metal rod and transfer their charge to the metal. For example, a summed charge can be measured as an electric current (“total mass current”).

The invention is explained in more detail below with reference to the attached figures using examples of embodiments. In the various figures, identical components are provided with identical reference numerals. The figures show:

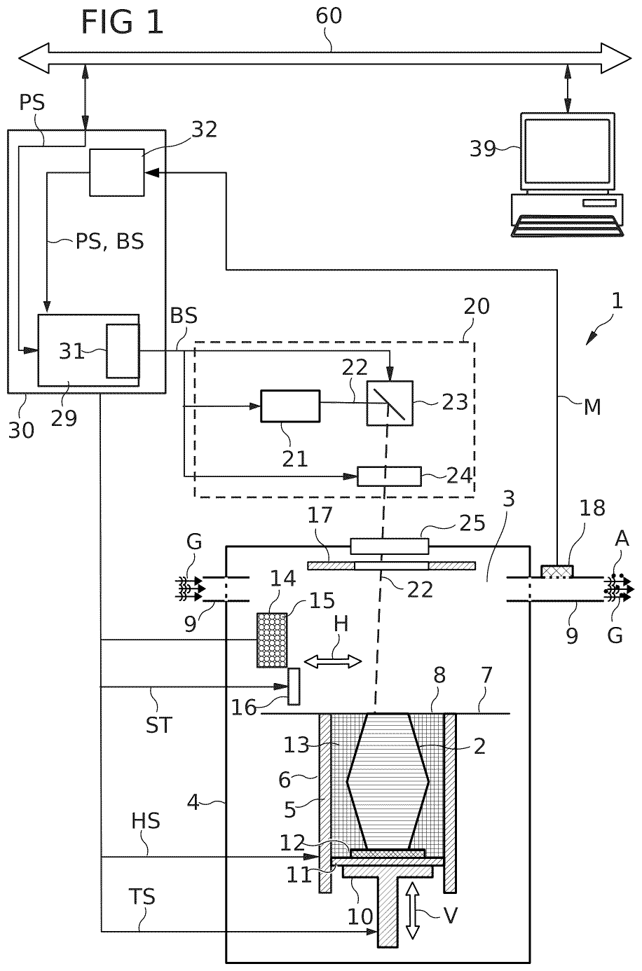

FIG. 1 a schematic view, partially shown in section, of an example of a device for additive manufacturing,

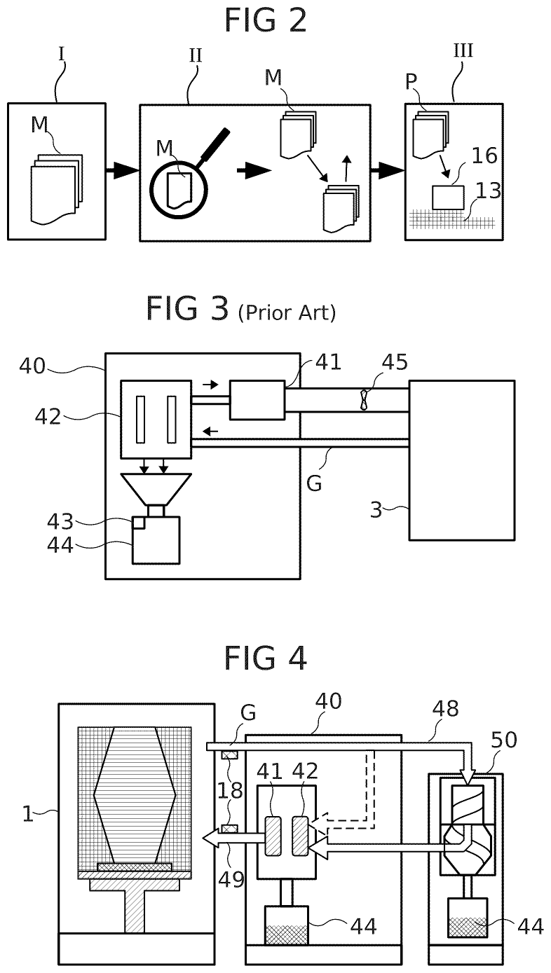

FIG. 2 a block diagram of a possible process sequence of an example of a method according to the invention,

FIG. 3 a circulating air filter system according to the state of the art,

FIG. 4 a manufacturing device with circulating air filter system and particle separator.

The following embodiments are described with reference to a device 1 for additive manufacturing of components in the form of a selective laser sintering or laser melting device, it being explicitly pointed out once again that the invention is not limited to selective laser sintering or laser melting devices. The device is therefore referred to in the following—without limiting the generality—as “manufacturing device” 1 for short.

Such a manufacturing device 1 is shown schematically in FIG. 1. The device has a process chamber 3 or a process space 3 with a chamber wall 4, in which the manufacturing process essentially takes place. An upwardly open container 5 with a container wall 6 is located in the process chamber 3. The upper opening of the container 5 forms the current working plane 7. The area of this working plane 7 located inside the opening of the container 5 can be used to construct the object 2 and is therefore referred to as the construction field 8.

The container 5 has a base plate 11 movable in a vertical direction V, which is arranged on a carrier 10. This base plate 11 closes the container 5 at the bottom and thus forms its base. The base plate 11 can be formed integrally with the carrier 10, but it can also be a plate formed separately from the carrier 10 and attached to the carrier 10 or simply mounted on it. Depending on the type of specific building material, for example the powder used, and the manufacturing process, a building platform 12 can be attached to the base plate 11 as a building base on which the object 2 is built. In principle, however, the object 2 can also be built on the base plate 11 itself, which then forms the building base.

The basic construction of the object 2 is carried out by first applying a layer of building material 13 to the building platform 12, then—as explained later—selectively solidifying the building material 13 with a laser beam 22 as an energy beam at the points which are to form parts of the object 2 to be manufactured, then lowering the base plate 11, and thus the building platform 12, with the aid of the carrier 10 and applying a new layer of the building material 13 and selectively solidifying it, and so on. In FIG. 1, the object 2 built up in the container on the building platform 12 below the working level 7 is shown in an intermediate state. It already has several solidified layers, surrounded by unconsolidated building material 13. Various materials can be used as building material 13, preferably powder, in particular metal powder, plastic powder, ceramic powder, sand, filled or mixed powders or also pasty materials and optionally a mixture of several materials.

Fresh building material 15 is located in a storage container 14 of the production device 1. The building material can be applied in the working plane 7 or within the construction field 8 in the form of a thin layer with the help of a layering device 16 that can be moved in a horizontal direction H.

Optionally, there is an additional radiation heater 17 in the process chamber 3, which can be used to heat the applied building material 13 so that the irradiation device used for selective solidification does not have to introduce too much energy. This means, for example, that a quantity of basic energy can already be introduced into the building material 13 with the aid of the radiation heater 17, which is of course still below the energy required for the building material 13 to fuse or sinter. For example, an infrared heater or VCSEL emitter can be used as the radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to scan the exposure paths or tracks (hatch lines) in the layer to be selectively solidified in accordance with the exposure strategy and to selectively introduce the energy. Further, this laser beam 22 is suitably focused onto the working plane 7 by a focusing device 24. The irradiation device 20 is preferably located here outside the process chamber 3 and the laser beam 22 is guided into the process chamber 3 via a coupling window 25 provided in the chamber wall 4 at the top of the process chamber 3.

For example, the irradiation device 20 may comprise not just one, but several lasers. Preferably, these may be gas or solid-state lasers or any other type of laser such as laser diodes, in particular VCSEL (Vertical Cavity Surface Emitting Laser) or VECSEL (Vertical External Cavity Surface Emitting Laser) or a line of these lasers. Most preferably, one or more unpolarized single-mode lasers, e.g. a 3 KW fiber laser with a wavelength of 1070 nm, can be used in the context of the invention.

The manufacturing device 1 contains a gas pipe 9, which feeds process gas G into the process space 3 and out of it, and a contamination measuring unit 18, which measures a degree of contamination in the process gas G flowing through the gas pipe 9. The gas stream flows through the gas-filled space above the container 5, through which the energy beam 22 passes during operation. Opposite the gas inlet (left) is a gas outlet (right) so that the gas flow completely crosses the construction field and can be returned if necessary (not shown). Here, a contamination A of a process gas G flowing out of the process chamber 3 is measured with the contamination measuring unit 18, but a contamination of the incoming process gas G can also be measured. The contamination measuring unit 18 can comprise, for example, a filter breakage sensor, an optical turbidity sensor, a camera, a thermo-optical measuring device or a system designed for powder bed monitoring.

The measuring values M recorded by the contamination measuring unit 18, which allow conclusions to be drawn about the respective degree of contamination in the process gas G flowing through the gas pipe 9, are transferred here to a control device 30 of the manufacturing device 1, which also serves to control the various components of the manufacturing device 1 for the overall control of the additive manufacturing process.

To record the measuring values M, the control device 30 has an evaluation unit 32, which is designed to evaluate the measuring values M. A control unit 29 of the control device 30 serves to control the device 1 depending on the number of measuring values M. The control unit 29 is designed to control the components of the irradiation device 20, namely here the laser 21, the deflection device 23 and the focusing device 24, and for this purpose transmits to them corresponding irradiation control data BS, which are designed in accordance with the measuring values M.

The control unit 29 also controls the radiation heating 17 by means of suitable heating control data HS, the layering device 16 by means of layering control data ST and the movement of the carrier 10 by means of carrier control data TS, thus controlling the layer thickness.

The control device 30 is coupled, here for example via a bus 60 or another data connection, to an output device 39, e.g. a terminal 40 with a display or the like. It can send warning messages to an output device 39 via this bus 60 if the degree of pollution is too high. Via the terminal, an operator can also control the control device 30 and thus the entire manufacturing device 1, e.g. by transmitting process control data PS.

It is also pointed out once again at this point that the present invention is not limited to such a manufacturing device 1. It can be applied to other methods for generative or additive manufacturing of a three-dimensional object by layer-by-layer application and selective solidification of a building material, wherein an energy beam for solidification is emitted onto the building material to be solidified. Accordingly, the irradiation device can also not only be a laser, as described here, but any device could be used with which energy can be selectively applied to or into the building material as wave or particle radiation. For example, another light source, an electron beam, etc. could be used instead of a laser.

Even if only a single object 2 or component 2 is shown in FIG. 1, it is possible and generally also common to produce several objects in parallel in the process chamber 3 or in the container 5. For this purpose, the building material is scanned layer by layer by the energy beam 22 at points that correspond to the cross-sections of the objects in the respective layer.

FIG. 2 shows a block diagram of a possible procedure of an embodiment example of a method according to the invention for controlling a manufacturing process for additive manufacturing of a component 2 in a device 1, as shown, for example, in FIG. 1. For this purpose, building material 13 is solidified on a construction field 8 in a process space 3 by irradiating the building material 13 with at least one energy beam 22. A process gas G loaded with contamination A is removed from the process space 3 through a gas pipe 9, filtered and returned to the process space 3. The building material 13 is at least partially in powder form and preferably comprises a metal powder. If a metal powder is processed, a passivating agent, preferably chalk particles, is often added to the process gas G flowing through the gas pipe 9 downstream of the process space 3 and/or upstream of a filter unit 40 (see figures below) for reasons of fire protection. All materials in powder form can be present as contamination in the process gas. In particular, if a filter or other component intended to separate clean gas from contaminated gas (e.g. a seal) cracks or breaks, non-negligible amounts of contaminants are then reintroduced into the process chamber 3 with the process gas G, resulting in a loss of quality in the components 2 produced.

In step I, a number of measuring values M are recorded by means of the contamination measuring unit 18, each measuring value M allowing a conclusion to be drawn as to a degree of contamination of the process gas G flowing through the gas pipe 9 at the time of the recording. A measuring value M can directly indicate this respective degree of contamination or represent a value with which the degree of contamination can be determined, e.g. based on the turbidity of optical images, e.g. of the powder bed monitoring system. The measuring values M are recorded here during additive manufacturing of a component 2, preferably continuously or at regular intervals.

In step II, the measured values M are evaluated. As part of the evaluation, it is determined whether a measured value M or a course of a plurality of measured values M is within a predetermined value range. The measuring values M can be evaluated in different ways. For example, a measuring value M or its change is compared with at least one predefined threshold value. A plurality of measuring values M can also be checked for a recurring measuring value pattern, wherein, for example, this check can include recognizing repeatedly occurring measuring value anomalies (e.g. temporary measuring value deflections). The evaluation may also comprise a formation of a temporal correlation between a result of a detection of the number of measuring values M and at least one process parameter P of the device 1, which is characteristic for an additive manufacturing of a component 2.

A process parameter P can be characteristic of one of the following criteria, for example:
a) A throughput, a flow rate, a direction, an effective range and/or a velocity of the process gas G in the process space 3, in particular in each case relative to an uppermost layer of the building material 13,
b) a geometric and/or temporal uniformity of a throughput, a flow rate, a direction, an effective range and/or a velocity of the process gas G in the process space 3, in particular in each case relative to an uppermost layer of the building material 13,
c) an area, thickness, position and/or shape of an area to be consolidated on the construction field 8 for the production of the component 2,
d) feeding and/or selective solidification of the building material 13,
e) a distribution (e.g. layer-by-layer application) of the building material 13,
f) the at least one energy beam 22, which causes the selective solidification of the construction material 13, in particular its wavelength, intensity, intensity distribution, beam diameter, beam cross-section, deflection direction, movement direction and/or movement speed within the construction field 8,
g) a filling and/or overfilling of an overflow container provided for collecting excess building material 13 in the Process space 3, or
h) an increased or uncontrolled discharge of building material 13 into an atmosphere of Process space 3.

In the step shown here, the evaluation of the number of measuring values M is carried out taking into account a number of process parameters P of the device 1 which is characteristic of additive manufacturing of a component 2, in particular assuming that the detected contamination is process-related discharge material and/or passivating agent.

In step III, the device 1 and/or an output device 39 data-technincally connected to the manufacturing process is controlled depending on the evaluation of the number of measuring values M. In this example, the device 1 is controlled by means of an automatic control or regulation of the number of process parameters P depending on the evaluation of the number of measuring values M, wherein optimization and/or error detection with respect to at least one process parameter can be carried out on the basis of the evaluation of the number of measuring values M. For example, for manufacturing a component 2 with a device according to FIG. 1, a dosing of the building material 13 by means of the layering device 16 or its movement can be controlled based on the measuring values M.

In the event that the evaluation of the measuring values M shows that the degree of contamination in the process gas G flowing through the gas pipe 9 is greater than a predetermined maximum contamination, a warning message is output on the output device 39, for example. In addition, the manufacturing process can be interrupted until the degree of contamination has decreased again and information about the degree of contamination can be automatically entered in a quality data log.

FIG. 3 shows a circulating air filter system 40 with a pre-filter stage 42, a particle collection container 44, a fill level sensor 43 for measuring the fill level in the particle collection container 44, a fine-filter stage 41 and a fan 45. As indicated by the arrows, process gas G flows from the process chamber 3 to the pre-filter 42 and is filtered there, wherein filtrate (particles) is separated into the particle collecting vessel 44 at certain intervals when the pre-filter 42 is cleaned. The pre-cleaned process gas G then flows through the fine-filter stage 41 before it is returned to the process chamber 3 by means of the fan 45. Such a circulating air filter system 40 is known in the prior art. In the event of a crack or break in the fine-filter stage 41, which does not necessarily have to be noticed, impurities can remain in the process gas G and re-enter the process chamber 3. This can jeopardize the production of components 2. With the method according to the invention, damage to a filter can be detected at an early stage and countermeasures or warnings can be initiated automatically.

FIG. 4 shows a manufacturing device 1 with circulating air filter system 40 and particle separator 50. Process gas G is discharged from the manufacturing device 1 (see e.g. FIG. 1) as raw gas, i.e. loaded with contamination, through a raw gas section 48 (upper arrow). It flows past a first contamination measuring unit 18 (top). It can now be fed directly into a pre-filter stage 42 and cleaned there (dashed arrow), but in this example it first flows through a particle separator 50, which removes particles from the process gas G by means of a cyclone and collects them in a particle collecting vessel 44. Only then does the process gas G flow through the pre-filter stage 42 and a fine-filter stage 41 through a clean gas section 49 back to the process chamber 3 of the manufacturing device 1, flowing past a second contamination measuring unit 18 (below). By simple measurements with the second contamination measuring unit 18 or a comparative measurement of both contamination measuring units 18, the degree of contamination of the process gas G returned through the clean gas section 49 can now be determined and, if necessary, measures can be initiated in accordance with the method according to the invention.

Finally, it should be pointed out once again that the devices described in detail above are merely examples of embodiments which can be modified by the skilled person in a wide variety of ways without departing from the scope of the invention. For example, solidification could also be carried out using other energy beams instead of laser light. Furthermore, the use of the indefinite articles “a” or “one” does not exclude the possibility that the features in question may be present more than once. Likewise, the term “unit” does not exclude the possibility that it consists of several interacting sub-components, which may also be spatially distributed. The term “a number” is to be understood as “at least one”.

### LIST OF REFERENCE SYMBOLS

1 Device for additive manufacturing/manufacturing device
2 Component/object
3 Process space/process chamber
4 Chamber wall
5 Container
6 Container wall
7 Working plane
8 Construction field
9 Gas pipe
10 Carrier
11 Base plate
12 Building platform
13 Building material (in container 5)
14 Storage container
15 Building material (in storage container 14)
16 Layering devices
17 Radiation heater
18 Contamination measuring unit
20 Irradiation device/exposure device
21 Laser
22 Laser beam/energy beam
23 Deflection device/scanner
24 Focusing device
25 Coupling windows
29 Control unit
30 Control device
31 Irradiation control interface
32 Evaluation unit
39 Terminal/output device
40 Circulating air filter system
41 Fine-filter stage
42 Pre-filter stage
43 Fill level sensor
44 Particle collecting vessel
45 Fan
48 Raw gas section
49 Clean gas section
50 Particle separator
60 Bus
A Contamination
BS control data/exposure control data
G Process gas
H horizontal direction
HS Heating control data
M Measuring value
P Process parameters
PS Process control data
ST Layering control data
TS Carrier control data
V vertical direction

1. A method for controlling a manufacturing process for additive manufacturing of a component in a device, wherein building material is solidified on a construction field in a process space by means of irradiation of the building material with at least one energy beam and wherein a process gas loaded with contamination is discharged from the process space through a gas pipe, filtered and returned to the process space, the method comprising the steps:
detection of a number of measuring values by means of a contamination measuring unit, each measuring value allowing an inference of to a degree of contamination of the process gas flowing through the gas pipe at the time of detection,
evaluation of the number of measuring values,
controlling the device and/or an output device data-technically connected to the manufacturing process in dependence on the evaluation of the number of measuring values.

2. The method according to claim 1, wherein in the event that the evaluation of the number of measuring values shows that the degree of contamination in the process gas flowing through the gas pipe is greater than a predetermined maximum contamination, at least one of the following steps is carried out:
output of a warning message or a warning signal,
interrupting the manufacturing process,
automatic entry of information about the degree of contamination in the process gas flowing through the gas pipe, determined from the number of measuring values, in a quality data log,
determination of a condition of a number of components produced in the manufacturing process and estimation of which of the number of components is/are usable and/or which is/are not.

3. The method according to claim 1, wherein for controlling the device
the evaluation of the number of measuring values is carried out taking into account a number of process parameters of the device which are characteristic of additive manufacturing of a component, and
the device is controlled by means of a control or regulation of the number of process parameters depending on the evaluation of the number of measuring values, wherein, with regard to the control or regulation of the number of process parameters, an optimization and/or an error detection occurs with regard to at least one process parameter taking place on the basis of the evaluation of the number of measuring values.

4. The method according to claim 3, wherein one process parameter of the number of process parameters is characteristic of at least one of the following criteria:
a throughput, a flow rate, a direction, an effective range and/or a velocity of the process gas in the process space, in each case relative to an uppermost layer of the building material,
a geometric and/or temporal uniformity of a throughput, a flow rate, a direction, an effective range and/or a velocity of the process gas in the process space, in each case relative to an uppermost layer of the building material,
an area, thickness, position and/or shape of an area to be consolidated on the construction field for manufacturing the component,
feeding and/or selective solidification of the building material,
a distribution of the building material,
the at least one energy beam which causes the selective solidification of the building material, its wavelength, intensity, intensity distribution, beam diameter, beam cross-section, direction of deflection, direction of movement and/or speed of movement within the construction field,
a filling and/or overfilling of an overflow container, which is provided for collecting excess building material in the process space,
an increased or uncontrolled discharge of building material into an atmosphere of the process space.

5. The method according to claim 1, wherein in the course of the evaluation it is determined whether a measuring value or a development of a plurality of measuring values is within a predetermined value range, wherein the number of measuring values is evaluated by
a measuring value is compared with at least one predefined threshold value and/or
a change in a number of measuring values is compared with at least one predefined threshold value and/or
a plurality of measuring values is checked for a repetitive pattern of measuring values, wherein the checking of the number of measuring values for the repetitive pattern of measuring values comprises a recognition of repeatedly occurring measuring value anomalies, which occur for a short time in comparison with the predetermined time period of the measuring value acquisition, wherein the evaluation of the number of measuring values comprises a formation of a temporal correlation between a result of a detection of the number of measuring values and at least one process parameter of the device which is characteristic for an additive manufacturing of a component.

6. The method according to claim 1, wherein the acquisition of a number of measuring values, and also the control or regulation of the process parameter, takes place during additive manufacturing of a component continuously or at regular time intervals.

7. The method according to claim 1, wherein the building material is at least partially powdery and comprises a metal powder.

8. The method according to claim 7, wherein a passivating agent is added to the process gas flowing through the gas pipe downstream of the process space and/or upstream of the filter unit.

9. The method according to claim 1, wherein the building material is fed into the process space for the production of a component and a dosing device is arranged in the process space and/or a layering device is arranged, which applies the building material layer by layer within a construction field, and wherein, in the course of controlling the device, depending on the number of measuring values
the building material is dosed by means of the dosing device and/or the layering device or is dosed in a modified manner
a movement of the dosing device and/or the laying device takes place or takes place in a modified manner.

10. A system for controlling a manufacturing process for additive manufacturing of a component in a device, wherein building material is solidified on a construction field in a process space by means of irradiation of the building material with at least one energy beam and wherein a process gas loaded with contamination is discharged from the process space through a gas pipe, filtered and returned to the process space, comprising the control system:
a contamination measuring unit designed to detect a number of measuring values, each measuring value allowing an inference of the degree of contamination in the process gas flowing through the gas pipe,
an evaluation unit designed for the evaluation of the number of measuring values,
a control unit designed for controlling the device and/or an output device data-technically connected to the manufacturing process in dependence on the evaluation of the number of measuring values,
wherein the system is designed for carrying out a method according to claim 1.

11. The system according to claim 10, which is designed as a retrofit kit for a device for additive manufacturing of a component and is designed so that the contamination measuring unit can be arranged in a gas pipe of the device and the evaluation unit and the control unit can be arranged or implemented in a control device of the device.

12. The system according to claim 10, wherein the contamination measuring unit comprises a filter breakage sensor and/or an optical turbidity sensor, and/or a camera, which monitors the brightness of images taken by the process atmosphere, and/or a thermo-optical measuring device and/or a system designed for powder bed monitoring, and/or a measuring device for comparative measurement of a pressure at two parallel filter stages.

13. A device for additive manufacturing of a component in a manufacturing process, in which building material is solidified on a construction field in a process space by means of irradiation of the building material with at least one energy beam, comprising the device:
a gas pipe for conducting a process gas from the process space through a filter unit and back into the process space,
a system according to claim 10, wherein the contamination measuring unit of the system is arranged on a clean gas side of the gas pipe.

14. The device according to claim 13, wherein the filter unit is designed to have at most one stage, and/or wherein all filter elements of the filter unit is/are designed to be cleaned before, during or after a manufacturing process,
wherein a particle separation unit is connected upstream of the filter unit.

15. A computer program loadable into a programmable control device, comprising a program code to perform all steps of a method according to claim 1 when the computer program is executed on the control device.
